(19) United States
(12) Patent Application Publication
(10) Pub. No.: US 2006/0143612 A1
(43) Pub. Date: Jun. 29, 2006

(54) Deskside device-based suspend/resume process

(75) Inventors: Daryl C. Cromer, Apex, NC (US); Howard J. Locker, Cary, NC (US); Randall S. Springfield, Chapel Hill, NC (US); Rod D. Waltermann, Rougemont, NC (US)

Correspondence Address: IBM CORPORATION (SYL-RPS), C/O SYNNESTVEDT & LECHNER LLP, 1101 MARKET STREET, SUITE 2600, PHILADELPHIA, PA, 19107, US

(73) Assignee: International Business Machines Corporation, Armonk, NY (US)

(21) Appl. No.: 11/023,787

(22) Filed: Dec. 28, 2004

(51) Int. Cl. G06F 9/46

(52) U.S. Cl. 718/100

(57) ABSTRACT

A screen saver is run from the deskside device of a workstation used by a first user, rather than from a blade being used by the first user. Screen saver software and the necessary hardware to run the screen saver are located on the deskside device, thereby making the screen saver independent from the blade. This enables the blade to be reallocated for use by a second user, in a manner that is transparent to the idle first user. When the first user wants to resume use of the computer system, a new blade (or the same blade, if available) is allocated to the first user, and the newly-allocated blade is restored to the status of the first blade at the time it entered its suspended state. From the perspective of the first user, nothing appears different, i.e., to the first user everything looks as though he or she is on the same blade as when they entered the idle state.

### BACKGROUND OF THE INVENTION

1. Field of the Invention

This invention relates to management of a suspend/resume process in a computer system and, more particularly, to management of the suspend/resume process using a desktop blade-based process.

2. Description of the Related Art

In the past, information handling systems, e.g., workstations, servers, etc. were essentially self-contained systems within an appropriate housing. For example, a desktop PC would consist of user interface elements (keyboard, mouse, and display) and a tower or desktop housing containing the CPU, power supply, communications components and the like. However, as demands on server systems and PC systems increased and with the increasing spread of networks and the services available through networks, alternate technologies have been proposed and implemented.

Blade computing is one such technology. A blade server provides functionality comparable to or beyond that previously available in a “free standing” or self-contained server, by housing a plurality of information handling systems in a compact space and a common housing. Each server system is configured to be present in a compact package known as a blade, which can be inserted in a chassis along with a number of other blades. At least some services for the blades, typically power supply, are consolidated so that the services can be shared among the blades housed in common. As blade technology has advanced, blade architecture has been developed whereby servers are packaged as single boards and designed to be housed in chassis that provide access to all shared services. In other words, blade servers today are single board units that slide into a slot in a housing in which other like boards are also housed.

While blade server technology changed the way in which servers were utilized and managed, on the client side (e.g., at the desktop level), things remained essentially the same. That is, each workstation still consisted of a desktop PC coupled, wirelessly or via Ethernet cables, to the “server farm” where the blade servers were stored. However, the next logical progression of blade technology was then applied to PCs, resulting in the “desktop blade”.

Similar to server blades, desktop blades involve the configuration of the major components of a PC onto a single card, and then storing/housing many such cards in a single chassis or housing. This allowed the moving of the processing power of the PC into a single location, leaving the workstation user with simply a keyboard, mouse, monitor, and a deskside device (a network port device such as a thin client, thick client, etc.) on the desktop. The deskside device connected the keyboard, mouse and monitor to the desktop blades via standard networking devices/cables, freeing up space in the user's work area.

On any computer system, including a desktop blade, many times a user will use the system for a set amount of time, and then the system will sit idle for long periods of time. As is well known, when a system is idled in this manner, typically a screen saver will run at the workstation when the blade is not in use. In prior art blade systems, the blade controls the operation of the screen saver and either stores the screen saver software on the blade or obtains it from a storage device associated with the blade; in either case, however, the screen saver is operated and controlled by the blade. As such, during these periods of time when the blade is idle, it is still assigned to the workstation and the blade is therefore tied up, unused, for long periods of time.

Accordingly, it would be desirable to be able to reallocate an idled blade for use by a second user while a first user is not using the blade, in a manner that is transparent to the first user.

### SUMMARY OF THE INVENTION

A screen saver is run from the deskside device of a workstation used by a first user, rather than from a blade being used by the first user. Screen saver software and the necessary hardware to run the screen saver are stored on the deskside device, thereby making the screen saver independent from the blade. This enables the blade to be reallocated for use by a second user, in a manner that is transparent to the idle first user. When the first user wants to resume use of the computer system, a new blade (or the same blade, if available) is allocated to the first user, and the newly-allocated blade is restored to the status of the first blade at the time it entered its suspended state. From the perspective of the first user, nothing appears different, i.e., to the first user everything looks as though he or she is on the same blade as when they entered the idle state.

### BRIEF DESCRIPTION OF THE DRAWINGS

FIG. 1 illustrates an exemplary blade environment in which both desktop blades and blade servers are utilized;

FIG. 2 is a flowchart illustrating the overall concept of the present invention; and

FIG. 3 is a flowchart illustrating the process involved in reassociating the workstation of the user with a desktop blade when the user wishes to resume activity.

### DETAILED DESCRIPTION OF THE PREFERRED EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

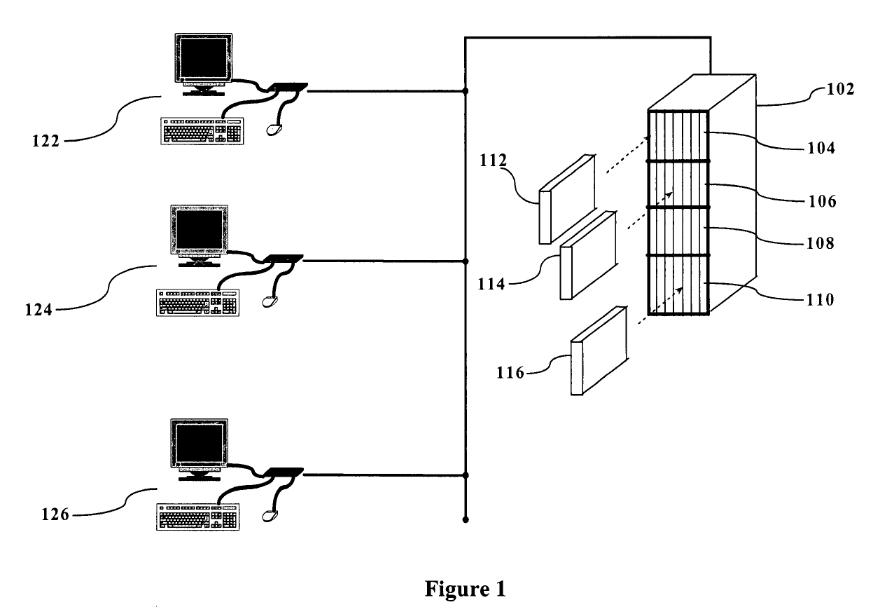

Referring now more particularly to the drawings, FIG. 1 illustrates an exemplary blade environment in which both desktop blades and blade servers are utilized. While the view is simplified and certain elements to be described herein are not visible in FIG. 1, the apparatus is shown to have a rack housing 102 in which are situated a plurality of chassis 104, 106, 108, and 110. Within the chassis, multiple blades, e.g., blades 112, 114, and 116, can be mounted. For example, in FIG. 1, blade 112 is illustrated as being mounted in chassis 104; blade 114 is shown as being mounted in chassis 106, and blade 116 is shown being mounted in chassis 110.

The blades illustrated in FIG. 1 are shown withdrawn from their respective chassis, with an indication that the blades may be inserted into the chassis. In a preferred embodiment, any type of blades can be stored in rack housing 102 and utilized by users via workstations (described below) as needed. For example, blade 112 can be a desktop blade, blade 114 can be a server blade, and blade 116 can be a storage blade (a blade devoted to storage space). It is understood that multiple rack housings may be used to, for example, keep all desktop blades in one rack, all server blades in another rack, and all storage blades in a different rack. However, from a performance viewpoint, it is preferable to have at least a set of desktop blades and the storage blade on which their image is stored all housed in the same rack. It is also understood that an external server can also be used as a storage device.

The rack housing 102 may also house a management module (not shown) for managing the flow of data to and from the blades, as well as to storage locations such as hard drives, ROM and the like. It is understood that, while a single rack housing 102 is illustrated, multiple rack housings may be interconnected in a single “blade center” and operate as essentially one chassis as shown. Further, although not shown, common elements, such as power supplies, a management module, cooling fans, etc. may also be included in rack housing 102.

Connected to rack housing 102 are workstations 122, 124, and 126. It is understood that although only three workstations are shown in FIG. 1, a single workstation or many more than three workstations may be attached to rack housing 102 in the manner shown in FIG. 1. In a typical desktop blade setup, the connection between workstations 122, 124, 126, and rack housing 102 is via an Ethernet connection. It is understood that any method of connecting the desktop stations to the rack housing may be utilized.

Workstations in a blade environment typically comprise a display device (e.g., a CRT) and user interface devices such as a keyboard and mouse. A deskside device (a network port device, such as a “thin client”, fat client, etc.) connects the keyboard, mouse and monitor to the desktop blades. The deskside device extracts video data from the signal it receives from the desktop blade via the Ethernet connection and drives the display with this video data. In addition, the desktop device takes keyboard and mouse input, packetizes it, and transmits it over the Ethernet connection to the desktop blade in rack housing 102.

In a typical desktop blade system such as that shown in FIG. 1, when a user wants to use a workstation, e.g., at workstation 122, a log-on process is activated whereby the user identifies himself or herself to the system and “requests” the allocation of a blade for use. It is understood that this request is essentially transparent, i.e., the user does not have to specifically submit a request for the blade, but instead, the act of logging on indicates to the system that the user is in need of a blade for use. Upon providing identifying information to the system, a management module (or a discrete server on the Ethernet configured for the same purpose) allocates a blade to the user and identifies the location where the user's user image is stored, e.g., on storage blade 116, and the user's user image is then directed to the particular desktop system where the user is logging on.

In prior art systems, when a user stops “input processing activity” (mouse movements, keyboard input, etc.) at the workstation for a predetermined time period, the screen saver or other user idle operations are automatically activated. This places the workstation in “user idle” mode pending the recommencement of user input processing activity at the workstation, thus leaving the allocated blade in an active state, running the screen saver or other user idle operation on the workstation. This also requires the connection/allocation between the desktop device and the allocated blade to be maintained, thereby precluding others from using that blade. As noted above, this is wasteful of resources, and the present invention, as described in more detail below, provides a solution for this problem.

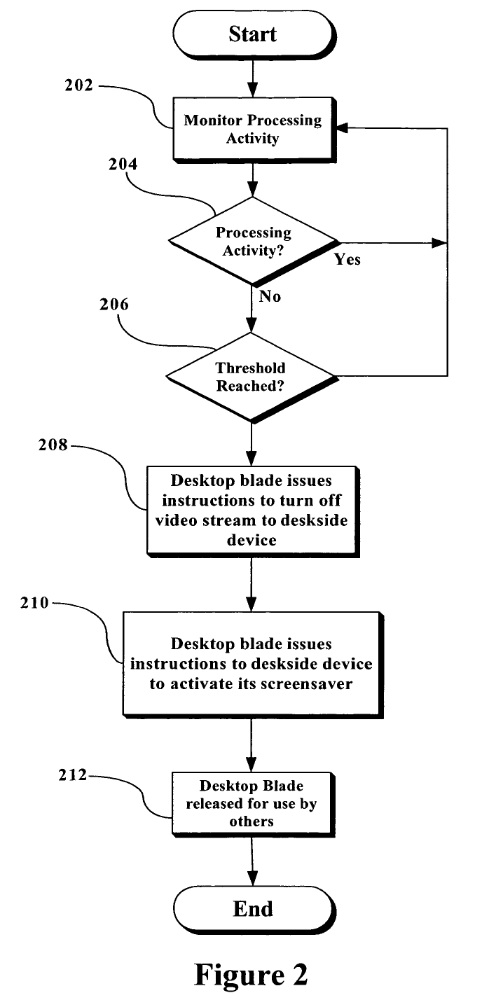

FIG. 2 illustrates the overall concept of the present invention. Referring to FIG. 2, the process of the present invention begins by monitoring the processing activity of the desktop blade being used by a first user (step 202). This monitoring process is a well known process. At step 204, it is determined if desktop blade processing activity is occurring. If processing activity is occurring, this is an indication that it is not an appropriate time to implement screen savers or other suspend mechanisms. Accordingly, the process proceeds back to step 202 to continue monitoring the processing activity. At some point, it is determined that the processing activity has ceased. After the system is idle for a specified timeframe, many users program the operating systems to start a screen saver.

When it has been sensed that processing activity has ceased, the process proceeds to step 206 and a threshold determination is performed to determine if the processing activity has ceased for a predetermined period of time. If the threshold has not been reached, the process proceeds back to step 202 to continue monitoring the processing activity (or lack thereof). When the threshold is reached, the process proceeds to step 208. The process up to this point is essentially the same as that in the prior art.

However, at step 208, when it is determined that the threshold has been reached, the desktop blade issues an instruction to the deskside device to turn off the video stream, and at step 210, the desktop blade issues instructions to the deskside device to activate a screen saver or other user idle mechanism stored on and controlled by the deskside device. At step 212, the desktop blade is released for use by others, and then the process ends. The desktop blade goes into hibernate mode or stores the memory map of the current user state in the storage blade. This results in a workstation running a user idle mechanism via its deskside device, and a desktop blade that can be used by other users.

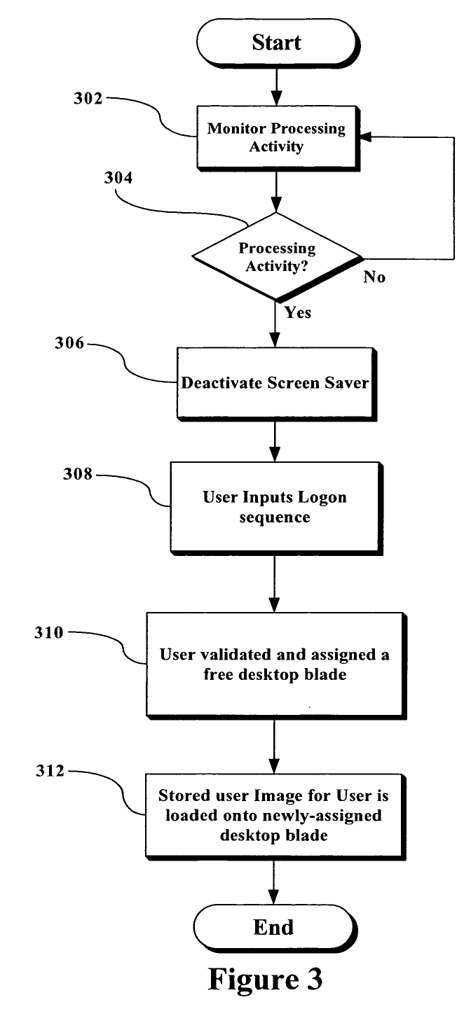

FIG. 3 illustrates the process involved in reassociating the workstation of the user with a desktop blade when the user wishes to resume activity. After the desktop blade has been released for use by others and the workstation coupled to the deskside device is running its screen saver or other user idle mechanism (according to the steps of FIG. 2), at step 302, the input activity (keyboard, mouse, etc.) of the deskside device is monitored, e.g., by the deskside device or any other known process. If there is no input activity sensed at step 304, the process loops back to step 302 and continues monitoring input activity. At some point, for example, when the user comes back to the workstation and presses a key, moves the mouse, etc., input activity will be sensed, and then the process proceeds to step 306.

At step 306, the screen saver is deactivated and the user is presented with a known log-in screen (step 308), e.g., a request for entry of a user name and password. The user inputs a log-in sequence and then, at step 310, the user is validated and assigned a free desktop blade from the blade farm. This may or may not be the same blade that the user was using when they entered their idle state, depending upon whether it is still being used by a different user.

At step 312, the stored hibernated user memory map from step 212, identified by the validation sequence, is loaded onto the newly assigned desktop blade. This provides the user with essentially the same image that was displayed on the workstation when he or she went into the idle state.

Thus, in accordance with the present invention, a screen saver or other suspend mechanism is stored on and controlled by the deskside device. By having a client-side screen saver/suspend mechanism, LAN traffic between the idle blade and the deskside device is eliminated.

There are numerous ways to store the screen saver/suspend mechanism on the deskside device. For example, since the desktop device has flash memory that stores logon screens, this same flash memory can be used to store the screen saver and processor instructions needed for the deskside device to run the screen saver. In addition, software code can be written using known techniques to interface with the operating system of the desktop blade, capture the screen saver the user had originally selected to be run from the blade, and transparently download the same screen saver to the flash memory of the deskside device prior to the severing of the connection between the deskside device and the blade.

When the blade is detected as having been idle for a set period of time, the blade issues instructions to the deskside device to turn off the video stream and issues another instruction causing the deskside device to activate its own screen saver/suspend mechanism. This can be done in numerous ways. Ethernet packets are already sent from the blade to the deskside device to, for example, control the logon sequence. A new command structure can easily be defined that instructs the deskside device to activate its onboard screen saver, etc. For example, a WOL format broadcast could be constructed whereby the header of the broadcast would be the MAC address of the deskside device repeated multiple, e.g., 16, times (to distinguish this WOL packet from random Ethernet traffic), then a new command field that instructs the system to disconnect from the network and run the local screensaver, and then the payload, e.g., the instructions to activate the screen saver.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a desktop blade or deskside device in the system. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of managing an idle process in a blade computing system that includes one or more deskside devices, comprising the steps of:
storing an idle process on each deskside device;
monitoring the processing operations of a desktop blade operationally associated with a first of said deskside devices; and
when processing activity of said desktop blade operationally associated with said first deskside device has ceased for a predetermined period of time, launching said idle process stored on said first deskside device and disassociating said desktop blade from said first deskside device.

2. The method of claim 1, further comprising the step of:
storing a memory map of said first deskside blade device to a storage blade prior to disassociating said desktop blade from said first deskside device.

3. The method of claim 2, wherein, upon disassociation of said desktop blade from said first deskside device, said desktop blade is available for association with any deskside device in said blade computing system.

4. The method of claim 3, further comprising the steps of:
monitoring the input activity of said first deskside device;
when input activity is detected on said first deskside device:
deactivating said idle process of said first deskside device;
associating said first deskside device with an available desktop blade in said blade computing system; and
loading said memory map of said first deskside device onto the available desktop blade associated with said first deskside device.

5. A system for managing an idle process in a blade computing system that includes one or more deskside devices, comprising:
means for storing an idle process on each deskside device;
means for monitoring the processing operations of a desktop blade operationally associated with a first of said deskside devices; and
means for launching said idle process stored on said first deskside device and disassociating said desktop blade from said first deskside device, when processing activity of said desktop blade operationally associated with said first deskside device has ceased for a predetermined period of time.

6. The system of claim 5, further comprising:
means for storing a memory map of said first deskside blade device to a storage blade prior to disassociating said desktop blade from said first deskside device.

7. The system of claim 6, wherein, upon disassociation of said desktop blade from said first deskside device, said desktop blade is available for association with any deskside device in said blade computing system.

8. The system of claim 7, further comprising:
means for monitoring the input activity of said first deskside device;
means for deactivating said idle process of said first deskside device when input activity is detected on said first deskside device;
means for associating said first deskside device with an available desktop blade in said blade computing system when input activity is detected on said first deskside device; and
means for loading said memory map of said first deskside device onto the available desktop blade associated with said first deskside device when input activity is detected on said first deskside device.

9. A computer program product for managing an idle process in a blade computing system that includes one or more deskside devices, the computer program product comprising a computer-readable storage medium having computer-readable program code embodied in the medium, the computer-readable program code comprising:
computer-readable program code for storing an idle process on each deskside device;
computer-readable program code for monitoring the processing operations of a desktop blade operationally associated with a first of said deskside devices; and
computer-readable program code for when processing activity of said desktop blade operationally associated with said first deskside device has ceased for a predetermined period of time, launching said idle process stored on said first deskside device and disassociating said desktop blade from said first deskside device.

10. The computer program product of claim 9, further comprising:
computer-readable program code for storing a memory map of said first deskside blade device to a storage blade prior to disassociating said desktop blade from said first deskside device.

11. The computer program product of claim 10, wherein, upon disassociation of said desktop blade from said first deskside device, said desktop blade is available for association with any deskside device in said blade computing system.

12. The computer program product of claim 11, further comprising:
computer-readable program code for monitoring the input activity of said first deskside device;
computer-readable program code for deactivating said idle process of said first deskside device when input activity is detected on said first deskside device;
computer-readable program code for associating said first deskside device with an available desktop blade in said blade computing system when input activity is detected on said first deskside device; and
computer-readable program code for loading said memory map of said first deskside device onto the available desktop blade associated with said first deskside device when input activity is detected on said first deskside device.
